(19) United States
(12) Patent Application Publication
(10) Pub. No.: US 2025/0079636 A1
(43) Pub. Date: Mar. 6, 2025

(54) POWER STORAGE CELL

(71) Applicant: TOYOTA JIDOSHA KABUSHIKI KAISHA, Toyota-shi Aichi-ken (JP)

(72) Inventors: Takeru HARA, Toyota-shi Aichi-ken (JP); Masato ONO; Satoshi MORIYAMA, Nagoya-shi Aichi-ken (JP); Hiroki AWANO, Susono-shi Shizuoka-ken (JP); Kazuya KUMAZAWA, Nagoya-shi Aichi-ken (JP); Seigo FUJISHIMA, Miyoshi-shi Aichi-ken (JP); Tomohiro INAGAKI, Okazaki-shi Aichi-ken (JP)

(73) Assignee: TOYOTA JIDOSHA KABUSHIKI KAISHA, Toyota-shi Aichi-ken (JP)

(21) Appl. No.: 18/812,454

(22) Filed: Aug. 22, 2024

(30) Foreign Application Priority Data
Aug. 29, 2023 (JP) 2023-138997

(51) Int. Cl. H01M 50/466

(52) U.S. Cl. CPC H01M 50/466

(57) ABSTRACT

A power storage cell includes the following configuration. The power storage cell includes a case, an electrode assembly, and an electrolyte solution. The case accommodates the electrode assembly and the electrolyte solution. The electrode assembly includes a first electrode, a second electrode, and a separator. The separator includes a mountain-fold portion and a valley-fold portion. The mountain-fold portions and the valley-fold portions are alternately arranged in a length direction of the separator. In the mountain-fold portion, the separator is bent in a mountain-folded manner toward outside of the electrode assembly. In the valley-fold portion, the separator is bent in a valley-folded manner toward the outside of the electrode assembly. The first electrode is disposed inside the mountain-fold portion. The second electrode is disposed inside the valley-fold portion. A through hole is formed at a tip of at least one of the mountain-fold portion and the valley-fold portion.

### CROSS REFERENCE TO RELATED APPLICATIONS

This nonprovisional application is based on Japanese Patent Application No. 2023-138997 filed on Aug. 29, 2023 with the Japan Patent Office, the entire contents of which are hereby incorporated by reference.

### BACKGROUND

### Field

The present disclosure relates to a power storage cell.

### Description of the Background Art

Japanese Patent Laying-Open No. 2021-044133 discloses a folded separator.

### SUMMARY

A power storage cell includes an electrode assembly and an electrolyte solution. The electrode assembly has, for example, a meandering structure. In the meandering structure, the separator is folded into a meandering shape. The separator is a porous film. When the electrolyte solution passes through the separator, the electrode assembly is impregnated with the electrolyte solution. In the meandering structure, the separator has a bent portion. Since it is difficult for the electrolyte solution to pass through the bent portion, it may take a long time to impregnate it with the electrolyte solution.

An object of the present disclosure is to reduce an impregnation time for an electrolyte solution.

1. In one aspect of the present disclosure, a power storage cell includes the following configuration. The power storage cell includes a case, an electrode assembly, and an electrolyte solution. The case accommodates the electrode assembly and the electrolyte solution. The electrode assembly includes a first electrode, a second electrode, and a separator. The separator includes a mountain-fold portion and a valley-fold portion. The mountain-fold portion and the valley-fold portion are alternately arranged in a length direction of the separator. In the mountain-fold portion, the separator is bent in a mountain-folded manner toward outside of the electrode assembly. In the valley-fold portion, the separator is bent in a valley-folded manner toward the outside of the electrode assembly. The first electrode is disposed inside the mountain-fold portion. The second electrode is disposed inside the valley-fold portion. The through hole is formed at a tip of at least one of the mountain-fold portion and the valley-fold portion.

Since the through hole is formed at the tip of the bent portion (the mountain-fold portion or the valley-fold portion) of the separator, it is expected that the electrolyte solution is facilitated to pass through the bent portion. That is, it is expected to reduce an impregnation time for the electrolyte solution.

2. The power storage cell according to “1” may include, for example, the following configuration. The tip at which the through hole is formed is set back toward inside of the electrode assembly.

Since the tip is set back toward the inside thereof, a flow path for the electrolyte solution can be formed. With the formation of the flow path, it is expected to reduce the impregnation time.

3. The power storage cell according to “1” or “2” may include, for example, the following configuration. The power storage cell has a height direction, a width direction, and a thickness direction. The height direction, the width direction, and the thickness direction are orthogonal to one another. The tip of the mountain-fold portion and the tip of the valley-fold portion are respectively disposed at both ends in the height direction.

4. The power storage cell according to any one of “1” to “3” may include, for example, the following configuration. The first electrode includes a first electrode tab. The second electrode includes a second electrode tab. In the width direction, the electrode assembly includes a first side end portion and a second side end portion. In the width direction, the second side end portion is located opposite to the first side end portion. The first electrode tab is disposed at the first side end portion. A second electrode tab is disposed at the second side end portion.

5. In one aspect of the present disclosure, a power storage cell may include the following configuration. The power storage cell includes a case, an electrode assembly, and an electrolyte solution. The case accommodates the electrode assembly and the electrolyte solution. The electrode assembly includes a first electrode, a second electrode, and a separator. The separator includes a mountain-fold portion and a valley-fold portion. The mountain-fold portion and the valley-fold portion are alternately arranged in a length direction of the separator. In the mountain-fold portion, the separator is bent in a mountain-folded manner toward the outside of the electrode assembly. In the valley-fold portion, the separator is bent in a valley-folded manner toward the outside of the electrode assembly. The first electrode is disposed inside the mountain-fold portion. The second electrode is disposed inside the valley-fold portion. A through hole is formed at a tip of at least one of the mountain-fold portion and the valley-fold portion.

The tip at which the through hole is formed is set back toward the inside of the electrode assembly.

The electrode assembly has a height direction, a width direction, and a thickness direction. The height direction, the width direction, and the thickness direction are orthogonal to one another. The tip of the mountain-fold portion and the tip of the valley-fold portion are respectively disposed at both ends in the height direction.

The first electrode includes a first electrode tab. The second electrode includes a second electrode tab. In the width direction, the electrode assembly includes a first side end portion and a second side end portion. In the width direction, the second side end portion is located opposite to the first side end portion. The first electrode tab is disposed at the first side end portion. The second electrode tab is disposed at the second side end portion.

Hereinafter, an embodiment (hereinafter, simply referred to as “the present embodiment”) of the present disclosure will be described. It should be noted that the present embodiment does not limit the technical scope of the present disclosure. The present embodiment is illustrative in any respects. The present embodiment is non-restrictive. The technical scope of the present disclosure includes any modifications within the scope and meaning equivalent to the terms of the claims. For example, it is initially expected to extract freely configurations from the present embodiment and combine them freely.

Geometric terms should not be interpreted in a strict sense. Examples of the geometric terms include “parallel”, “perpendicular”, “orthogonal”, and the like. For example, the term “parallel” may be deviated to some extent from the strict definition of the term “parallel”. The geometric terms can include, for example, a tolerance, an error, and the like in terms of design, operation, manufacturing, and the like. A dimensional relation in each of the figures may not coincide with an actual dimensional relation. In order to facilitate understanding of the reader, the dimensional relation in each figure may be changed. For example, length, width, thickness, or the like may be changed. Further, part of configurations may be omitted.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a first schematic cross-sectional view showing an example of an electrode assembly according to the present embodiment.

FIG. 2 is a schematic plan view showing an example of a separator in the present embodiment.

FIG. 3 is an enlarged view of a region III in FIG. 1.

FIG. 4 is a schematic perspective view showing an example of a power storage cell according to the present embodiment.

FIG. 5 is a schematic cross-sectional view showing an example of a power storage cell according to the present embodiment.

FIG. 6 is a second schematic cross-sectional view illustrating an example of the electrode assembly according to the present embodiment.

### DESCRIPTION OF THE EMBODIMENTS

### 1. Electrode Assembly

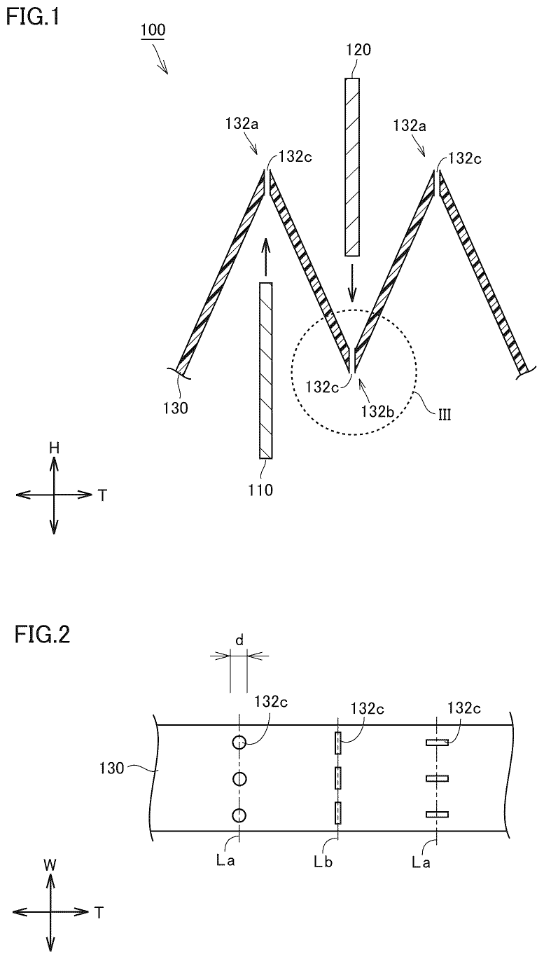

FIG. 1 is a first schematic cross-sectional view showing an example of an electrode assembly according to the present embodiment. The electrode assembly 100 has a meandering structure. The electrode assembly 100 includes a first electrode 110, a second electrode 120, and a separator 130. The separator 130 is folded in a meandering manner. That is, the separator 130 includes a mountain-fold portion 132a and a valley-fold portion 132b. The direction T in FIG. 1 is the length direction of the separator 130. The mountain-fold portions 132a and the valley-fold portions 132b are alternately arranged in the T direction. The “meandering shape” can also be expressed as, for example, “bellows shape”, “accordion shape”, or the like.

The H direction in FIG. 1 is the height direction of the electrode assembly 100. The tip of the mountain-fold portion 132a is disposed at one end in the H direction. The tip of the valley-fold portion 132b is disposed at the other end in the H direction. That is, the tip of the mountain-fold portion 132a and the tip of the valley-fold portion 132b are disposed at both ends in the H direction, respectively. In the mountain-fold portion 132a, the separator 130 is bent in a mountain-folded manner toward the outside of the electrode assembly 100. In the valley-fold portion 132b, the separator 130 is bent in a valley-folded manner toward the outside of the electrode assembly 100. The first electrode 110 is disposed inside the mountain-fold portion 132a. The second electrode 120 is disposed inside the valley-fold portion 132b. The second electrode 120 faces the first electrode 110 with the separator 130 interposed therebetween.

A through hole 132c is formed at the tip of at least one of the mountain-fold portion 132a and the valley-fold portion 132b. The through hole 132c may be formed at the tip of the mountain-fold portion 132a or the valley-fold portion 132b. The through hole 132c may be formed at the tips of both the mountain-fold portion 132a and the valley-fold portion 132b. When the electrolyte solution passes through the through hole 132c, a reduction in impregnation time of the electrolyte solution is expected.

FIG. 2 is a schematic plan view showing an example of a separator in the present embodiment. The through hole 132c has any planar shape. The through hole 132c may be, for example, a circular hole, an elliptical hole, a square hole, an oval hole, an oval hole, or the like. The maximum diameter d of the through hole 132c may be, for example, 0.1 mm or more, 0.2 mm or more, 0.3 mm or more, 0.4 mm or more, 0.5 mm or more, 0.6 mm or more, 0.7 mm or more, 0.8 mm or more, 0.9 mm or more, or 1 mm or more. The maximum diameter d of the through hole 132c may be, for example, 5 mm or less, 3 mm or less, 2 mm or less, 1 mm or less, or 0.5 mm or less.

The through hole 132c may extend linearly. For example, the through hole 132c may extend along the mountain-fold line La. For example, the through hole 132c may intersect with the mountain-fold line La. For example, the through hole 132c may extend along the valley-fold line Lb. For example, the through hole 132c may intersect with the valley-fold line Lb. For example, the separator 130 may be cut to form a through hole 132c extending linearly.

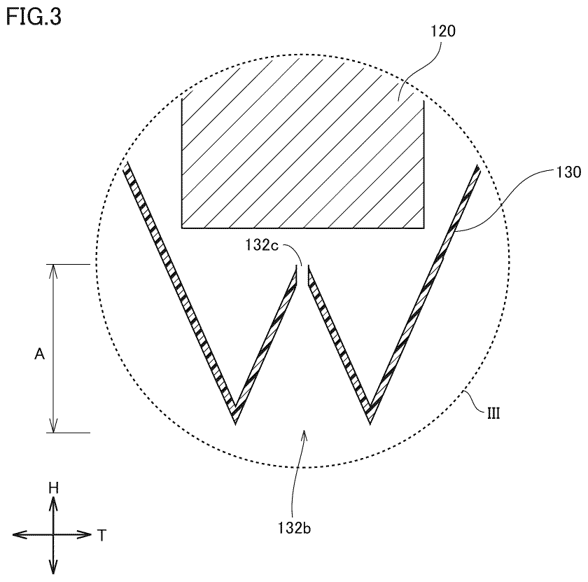

FIG. 3 is an enlarged view of a region III in FIG. 1. The tip at which the through hole 132c is formed may be set back toward the inside of the electrode assembly 100. Since the tip is set back, for example, a flow path of the electrolyte solution is expected to be formed in the depth direction (W direction) in FIG. 3. The formation of the circulation path is expected to shorten the impregnation time of the electrolyte solution. The setback amount A indicates the depth of the recess of the tip. The setback amount A may be, for example, 0.1 mm or more, 0.2 mm or more, 0.3 mm or more, 0.4 mm or more, 0.5 mm or more, 0.6 mm or more, 0.7 mm or more, 0.8 mm or more, 0.9 mm or more, or 1 mm or more. The setback amount A may be, for example, 5 mm or less, 3 mm or less, 2 mm or less, 1 mm or less, or 0.5 mm or less.

### 2. Power Storage Cell

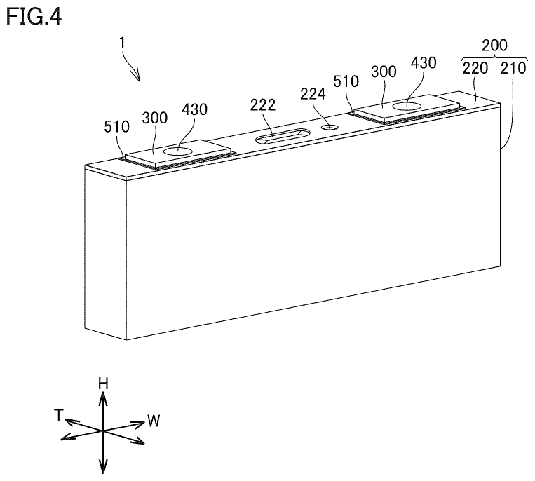

FIG. 4 is a schematic perspective view showing an example of a power storage cell according to the present embodiment. The power storage cell 1 may have, for example, a height direction, a width direction, and a thickness direction. The height direction, the width direction, and the thickness direction are orthogonal to one another. The “height direction” is the H direction in FIG. 4 and the like. The “width direction” is the W direction in FIG. 4 and the like. The “thickness direction” is the T direction in FIG. 4 and the like. The height direction may be parallel to the vertical direction, for example. The width direction and the thickness direction may be parallel to the horizontal direction, for example. The “height” indicates the dimension in the height direction. The “width” indicates a dimension in the width direction. The term “thickness” refers to the dimension in the thickness direction or the thickness of an object.

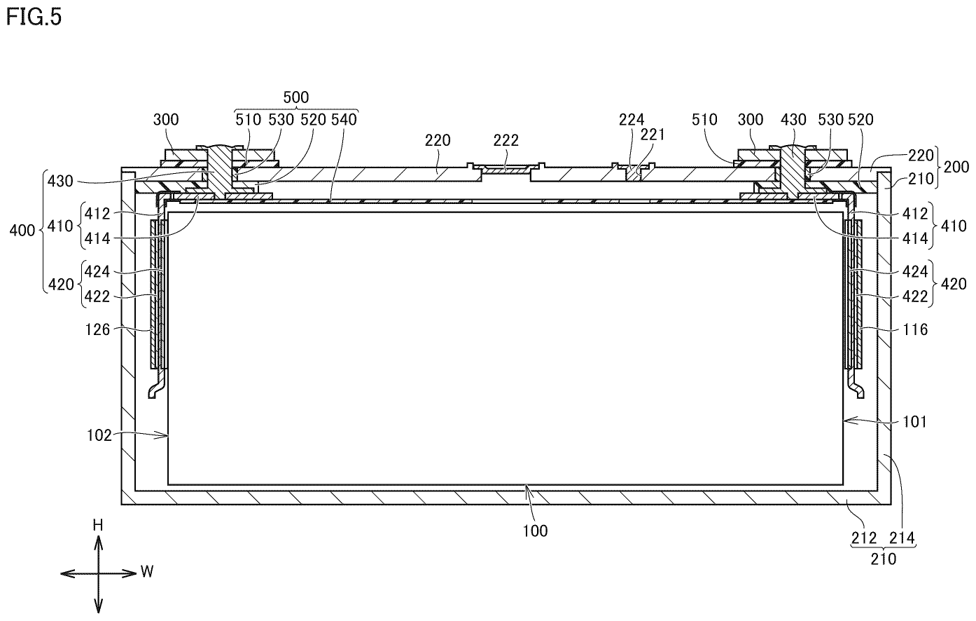

FIG. 5 is a schematic cross-sectional view showing an example of a power storage cell according to the present embodiment. FIG. 5 shows a cross section perpendicular to the T direction. The power storage cell 1 includes a case 200, an electrode assembly 100, and an electrolyte solution (not shown). The electrolyte solution is a liquid electrolyte. The electrolyte solution may contain, for example, an organic solvent and a lithium salt.

The electrode assembly 100 may be covered with an insulating film (not shown). The electrode assembly 100 may have, for example, a cubic outer shape. The electrode assembly 100 may have, for example, a rectangular parallelepiped outer shape. The electrode assembly 100 may have, for example, a flat rectangular parallelepiped shape. The “first aspect ratio” indicates the ratio of the width to the height in the electrode assembly 100. The first aspect ratio may be, for example, 1 or more, 1.5 or more, 2 or more, 2.5 or more, 3 or more, 5 or more, or 10 or more. The first aspect ratio may be, for example, 10 or less, 5 or less, 3 or less, 2.5 or less, 2 or less, or 1.5 or less. The “second aspect ratio” indicates the ratio of the thickness to the height in the electrode assembly 100. The second aspect ratio may be, for example, 0.1 or more, 0.2 or more, 0.3 or more, 0.5 or more, or 1 or more. The second aspect ratio may be, for example, 1 or less, 0.5 or less, 0.3 or less, or 0.2 or less.

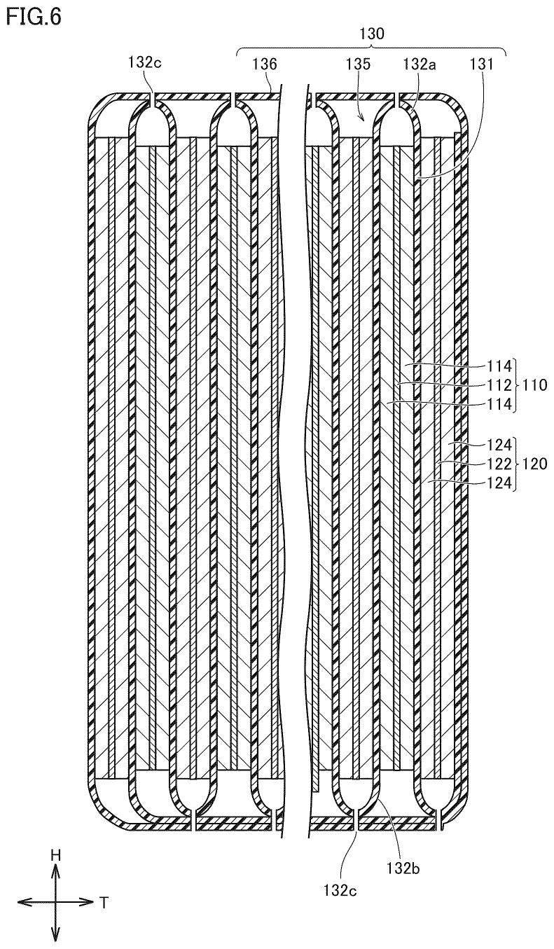

FIG. 6 is a second schematic cross-sectional view illustrating an example of the electrode assembly according to the present embodiment. The electrode assembly 100 includes one or more first electrodes 110, one or more second electrodes 120, and one or more separators 130. In the T direction, the first electrodes 110 and the second electrodes 120 are alternately stacked. That is, the T direction of the power storage cell 1 is parallel to the stacking direction of the first electrode 110 and the second electrode 120. Each of the numbers of the first electrodes 110 and the second electrodes 120 may be 2 or more, 5 or more, 10 or more, 50 or more, or 100 or more. Each of the numbers of the first electrodes 110 and the second electrodes 120 may be 200 or less, 100 or less, 50 or less, 10 or less, or 5 or less.

The second electrode 120 has a polarity different from that of the first electrode 110. For example, the first electrode 110 may be a positive electrode, and the second electrode 120 may be a negative electrode. For example, the first electrode 110 may be a negative electrode, and the second electrode 120 may be a positive electrode.

The first electrode 110 may include, for example, a first current collector 112 and a first active material layer 114. The first current collector 112 may include, for example, a metal foil or the like. The metal foil may contain, for example, Al, Cu, Ni, Ti, Fe, or the like. The first active material layer 114 is disposed on the surface of the first current collector 112. The first active material layer 114 may be disposed on only one surface of the first current collector 112. The first active material layer 114 may be disposed on both surfaces of the first current collector 112. The first active material layer 114 includes a positive electrode active material or a negative electrode active material. The positive electrode active material may include, for example, a lithium-nickel composite oxide or the like. The negative electrode active material may contain, for example, graphite, SiO, Si, or the like.

The second electrode 120 may include, for example, a second current collector 122 and a second active material layer 124. The second current collector 122 may include, for example, a metal foil or the like. The second active material layer 124 is disposed on the surface of the second current collector 122. The second active material layer 124 may be disposed on only one surface of the second current collector 122. The second active material layer 124 may be disposed on both surfaces of the second current collector 122. The second active material layer 124 includes a positive electrode active material or a negative electrode active material. The area of the second active material layer 124 may be the same as or different from that of the first active material layer 114. For example, the area of the second active material layer 124 may be larger than the area of the first active material layer 114. The ratio of the area of the second active material layer 124 to the area of the first active material layer 114 may be, for example, 1.01 or more, 1.05 or more, or 1.1 or more. The ratio of the area of the second active material layer 124 to the area of the first active material layer 114 may be, for example, 1.1 or less, 1.05 or less, or 1.01 or less.

The separator 130 has electrical insulation properties. The separator 130 is porous. The separator 130 may include, for example, a microporous polyolefin film or the like. The thickness of the separator 130 may be, for example, 5 to 50 μm, 5 to μm, or 5 to 15 μm. The separator 130 separates the first electrode 110 from the second electrode 120.

Separator 130 includes a meandering portion 135. The meandering portion 135 includes a mountain-fold portion 132a, a planar portion 131, and a valley-fold portion 132b. In the planar portion 131, the separator 130 extends in a planar shape. In the mountain-fold portion 132a and the valley-fold portion 132b, the separator 130 is folded back. The separator 130 is folded so as to alternately sandwich the first electrode 110 or the second electrode 120. The planar portion 131 sandwiches the first electrode 110 or the second electrode 120.

Separator 130 may further include, for example, an outer peripheral portion 136. The outer peripheral portion 136 may be wound so as to wrap around the meandering portion 135. The separator 130 may be folded back at both ends in the W direction to form a meandering portion.

A through hole 132c is formed at the tip of at least one of the mountain-fold portion 132a and the valley-fold portion 132b. The through hole 132c may also penetrate the outer peripheral portion 136. The through holes 132c of the mountain-fold portion 132a and the valley-fold portion 132b may be continuous with the through holes 132c of the outer peripheral portion 136, or may be independent from each other.

The case 200 accommodates the electrolyte solution and the electrode assembly 100. The case 200 may be hermetically sealed. The case 200 may be sealed. The case 200 may include, for example, a container 210 and a lid 220. The container 210 has an opening. The opening is open in the H direction. The container 210 may be made of metal, for example. The container 210 may include, for example, Al or the like. The container 210 may include, for example, a bottom wall 212 and a peripheral wall 214. The bottom wall 212 may have, for example, a flat plate shape. The planar shape of the bottom wall 212 may be, for example, rectangular. The peripheral wall 214 stands from the bottom wall 212. The peripheral wall 214 may have, for example, a quadrangular tubular shape. The width of the peripheral wall 214 may be greater than the thickness of the peripheral wall 214. The height of the peripheral wall 214 may be greater than the thickness of the peripheral wall 214. Here, the “thickness of the peripheral wall 214” indicates the external dimension of the case 200 in the thickness direction.

The lid 220 closes the opening of the container 210. The lid 220 may be welded to the peripheral wall 214. The lid 220 may have, for example, a flat plate shape. The lid 220 may be made of metal, for example. The lid 220 may include, for example, Al or the like. The lid 220 may include, for example, a pressure-release valve 222 and a sealing member 224.

The pressure-release valve 222 may be located, for example, near the center of the lid 220. The pressure-release valve 222 releases the internal pressure of the case 200. Once the internal pressure becomes equal to or more than the setting value, the pressure-release valve 222 may be opened. The sealing member 224 seals the injection hole 221. The electrolyte solution may be injected through the injection hole 221.

The pair of external terminals 300 is fixed to the lid 220. The external terminal 300 is connected to the first electrode 110 or the second electrode 120. The external terminal 300 may be made of metal, for example. The external terminal 300 may include Al, Cu, Ni, or the like. The external terminal 300 may have, for example, a rectangular parallelepiped outer shape. The external terminal 300 may be connected to a bus bar (not shown).

The pair of coupling members 400 connects the electrode tab to the external terminal 300. The two coupling members 400 may have substantially the same structure. The electrode tab indicates the first electrode tab 116 or the second electrode tab 126. The first electrode 110 includes a first electrode tab 116. The second electrode 120 includes a second electrode tab 126. In the W direction, the electrode assembly 100 includes a first side end portion 101 and a second side end portion 102. In the W direction, the second side end portion 102 is located opposite to the first side end portion 101. A first electrode tab 116 is disposed at the first side end portion 101. A second electrode tab 126 is disposed at the second side end portion 102.

The coupling member 400 may include, for example, a current collecting tab 410, a sub-tab 420, and a coupling pin 430. The current collecting tab 410 includes a side portion 412 and an upper portion 414. The side portion 412 is located on the side of the electrode assembly 100 in the W direction. The upper portion 414 is located above the electrode assembly 100. The upper portion 414 extends inward in the W direction from the upper end of the side portion 412.

Sub-tab 420 connects the plurality of electrode tabs to current collecting tab 410. The sub-tab 420 may include a first end portion 422 and a second end portion 424. The first end portion 422 is connected to the plurality of electrode tabs. The second end portion 424 is connected to the side portion 412.

The coupling pin 430 connects the current collecting tab 410 to the external terminal 300. The coupling pin 430 couples the upper portion 414 and the external terminal 300. For example, the lower end portion of the coupling pin 430 may be inserted into a through hole provided in the upper portion 414.

The insulating member 500 insulates the case 200 from the coupling member 400. The insulating member 500 may include, for example, a first portion 510, a second portion 520, a third portion 530, and a fourth portion 540.

The first portion 510 is fixed to the upper surface of the lid 220. The first portion 510 is disposed between the lid 220 and the external terminal 300. The second portion 520 is fixed to the lower surface of the lid 220. The second portion 520 is disposed between the lid 220 and the upper portion 414. The second portion 520 is disposed between the lid 220 and the lower portion of the coupling pin 430. The third portion 530 is disposed between the coupling pin 430 and the lid 220. The third portion 530 has a tubular shape. The third portion 530 surrounds the coupling pin 430. The first portion 510, the second portion 520, and the third portion 530 are provided with through holes. The coupling pin 430 is inserted through the through hole.

The fourth portion 540 has a plate shape. It is fixed to the lower surface of the upper portion 414. The fourth portion 540 is disposed above the electrode assembly 100. In the fourth portion 540, a through hole is provided below the pressure-release valve 222. In the fourth portion 540, a through hole is also provided below the injection hole 221.

What is claimed is:

1. A power storage cell comprising:
a case;
an electrode assembly; and
an electrolyte solution, wherein
the case accommodates the electrode assembly and the electrolyte solution,
the electrode assembly includes a first electrode, a second electrode, and a separator,
the separator includes a mountain-fold portion and a valley-fold portion,
the mountain-fold portion and the valley-fold portion are alternately arranged in a length direction of the separator,
in the mountain-fold portion, the separator is bent in a mountain-folded manner toward outside of the electrode assembly,
in the valley-fold portion, the separator is bent in a valley-folded manner toward the outside of the electrode assembly,
the first electrode is disposed inside the mountain-fold portion,
the second electrode is disposed inside the valley-fold portion, and
a through hole is formed at a tip of at least one of the mountain-fold portion and the valley-fold portion.

2. The power storage cell according to claim 1, wherein the tip at which the through hole is formed is set back toward inside of the electrode assembly.

3. The power storage cell according to claim 1, wherein
the power storage cell has a height direction, a width direction, and a thickness direction,
the height direction, the width direction, and the thickness direction are orthogonal to one another, and
the tip of the mountain-fold portion and the tip of the valley-fold portion are respectively disposed at both ends in the height direction.

4. The power storage cell according to claim 3, wherein
the first electrode includes a first electrode tab,
the second electrode includes a second electrode tab,
in the width direction, the electrode assembly includes a first side end portion and a second side end portion,
in the width direction, the second side end portion is located opposite to the first side end portion,
the first electrode tab is disposed at the first side end portion, and
the second electrode tab is disposed at the second side end portion.

5. A power storage cell comprising:
a case;
an electrode assembly; and
an electrolyte solution, wherein
the case accommodates the electrode assembly and the electrolyte solution,
the electrode assembly includes a first electrode, a second electrode, and a separator,
the separator includes a mountain-fold portion and a valley-fold portion,
the mountain-fold portion and the valley-fold portion are alternately arranged in a length direction of the separator,
in the mountain-fold portion, the separator is bent in a mountain-folded manner toward outside of the electrode assembly,
in the valley-fold portion, the separator is bent in a valley-folded manner toward the outside of the electrode assembly,
the first electrode is disposed inside the mountain-fold portion,
the second electrode is disposed inside the valley-fold portion,
a through hole is formed at a tip of at least one of the mountain-fold portion and the valley-fold portion,
the tip at which the through hole is formed is set back toward inside of the electrode assembly,
the power storage cell has a height direction, a width direction, and a thickness direction,
the height direction, the width direction, and the thickness direction are orthogonal to one another,
the tip of the mountain-fold portion and the tip of the valley-fold portion are respectively disposed at both ends in the height direction,
the first electrode includes a first electrode tab,
the second electrode includes a second electrode tab,
in the width direction, the electrode assembly includes a first side end portion and a second side end portion,
in the width direction, the second side end portion is located opposite to the first side end portion,
the first electrode tab is disposed at the first side end portion, and
the second electrode tab is disposed at the second side end portion.
